(19) United States
(12) Patent Application Publication
(10) Pub. No.: US 2005/0078183 A1
(43) Pub. Date: Apr. 14, 2005

(54) Image pickup device and image pickup method

(76) Inventors: Hiroshi Yoshimura, Saitama-shi (JP); Yasuhito Ambiru, Tokorozawa-shi (JP); Isao Ooshima, Kawasaki-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/901,413

(22) Filed: Jul. 29, 2004

(30) Foreign Application Priority Data
Jul. 30, 2003 (JP) 2003-282907

(51) Int. Cl. H04N 7/14

(52) U.S. Cl. 348/143; 375/240; 375/250

(57) ABSTRACT

An image pickup device has an image pickup portion for picking up an image, a communication portion for making communication via a local area network N, and a router portion connected to the communication portion to transmit image information picked up by the image pickup portion via either of the local area network and a wide area network W, wherein connection can be easily made to the Internet, and a communication function using the router portion can be improved.

### CROSS-REFERENCE TO RELATED APPLICATIONS

This application is based upon and claims the benefit of priority from prior Japanese Patent Application No. 2003-282907, filed Jul. 30, 2003, the entire contents of which are incorporated herein by reference.

### BACKGROUND OF THE INVENTION

1. Field of the Invention

The present invention relates to an image pickup device such as a network camera, and more particularly, the invention relates to an image pickup device connected to a wide area network (such as the Internet) to transmit image information, and an image pickup method.

2. Description of the Related Art

In recent years, with the spread of digital equipment, various types of image information equipment such as a digital camera have been developed and manufactured. As such image information equipment, for example, there is used an image pickup device such as a monitor camera having a networking function.

A prior art (Jpn. Pat. Appln. KOKAI Publication No. 2002-94734) discloses that browser software such as a general purpose browser is used as an image server of such an image pickup device to display a plurality of images from a plurality of image servers on a screen of a computer apparatus.

However, in the above-described prior art, a description is given with respect to processing of distributing image information contained in a local area network in which predetermined stability has been guaranteed, and there is no specific disclosure in the case where connection is made to a network with high risk of information dispersion in a wide area network (such as the Internet). That is, in the case where a network camera is connected to the wide area network, if the network camera is directly connected to a DSL modem or the like, another PC (Personal Computer) or a LAN cannot be connected. Thus, there is a need for externally providing a router device or the like, and there is a problem that a camera simplex cannot be connected, so that a system becomes complicated. Further, there is a problem that privacy information or the like is dispersed with carelessness via the wide area network (such as Internet).

### BRIEF SUMMARY OF THE INVENTION

According to one aspect of the embodiments of the present invention, there is provided an image pickup device comprises an image pickup portion which picks up an image; a communication portion which makes communication via a local area network; and a router portion connected to the communication portion to transmit image information picked up by the image pickup portion via either of the local area network and a wide area network.

### BRIEF DESCRIPTION OF THE SEVERAL VIEWS OF THE DRAWING

FIG. 1 is a block diagram depicting one embodiment of a configuration of an image pickup device according to the present invention;

FIG. 2 is an illustrative view illustrating an example of a method of making connection with a network of the image pickup device according to the invention;

FIG. 3 is a sectional view showing one embodiment of the configuration of the image pickup device according to the invention;

FIG. 4 is a flow chart showing an example of a communication method with protection processing for the image pickup device according to the invention;

FIG. 5 is a flow chart showing an example of a method of setting a transmission protecting region of the image pickup device according to the invention;

FIG. 6 is an illustrative view illustrating an example of an operating screen for setting the transmission protecting region of the image pickup device according to the invention;

FIG. 7 is an illustrating view illustrating an example of setting a transmission protecting region in an image pickup enable range in the image pickup device according to the invention; and

FIG. 8 is an illustrative view illustrating an example of a connecting method in the image pickup device according to the invention.

### DETAILED DESCRIPTION OF THE INVENTION

Hereinafter, a network camera which is an image pickup device according to the present invention will be described with reference to the accompanying drawings.

<Network Camera Which is an Image Pickup Device According to the Present Invention>

(Configuration)

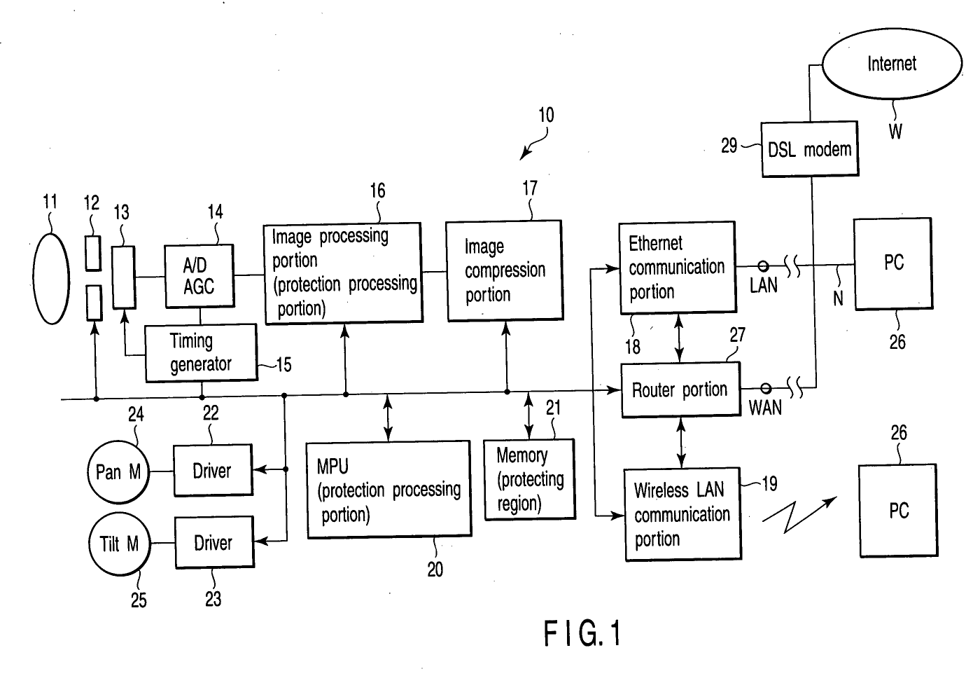

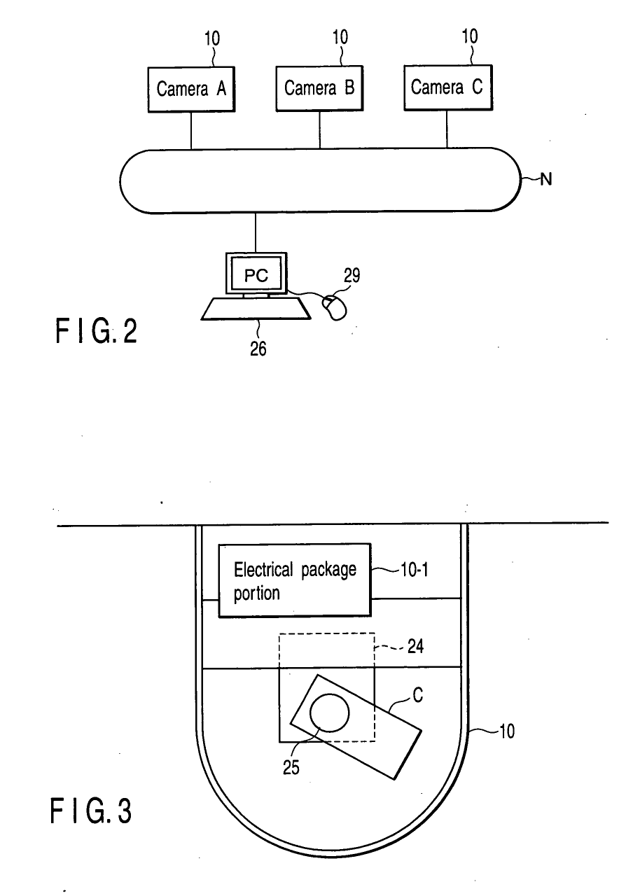

An image pickup device and an image pickup system according to the present invention will be described below with reference to the accompanying drawings by way of example of a network camera and a PC (Personal Computer) connected to a network. FIG. 1 is a block diagram depicting one embodiment of a configuration of the image pickup device according to the invention; FIG. 2 is an illustrative view illustrating an example of a method of making connection with a network of the image pickup device according to the invention; and FIG. 3 is a sectional view showing one embodiment of the configuration of the image pickup device according to the invention.

A network camera device 10 which is the image pickup device according to the invention, as shown in FIG. 1, comprises: an objective lens 11; and a solid image pickup element 13 such as a CCD (Charge Coupled Device) for receiving incident light transmitted through the lens and outputting a detection signal according to the incident light. Further, the image pickup device 10 comprises: an image processing portion 16 for receiving an output from the solid pickup device 13; and an image compression portion 17 for carrying out compression processing such as MPEG compression or JPEG compression for the thus image-processed image signal. At the image processing portion 16, image processing such as, for example, sharpness processing, contrast processing, Gamma correction, white balance processing, or pixel addition processing is applied to the inputted image signal.

Further, the network camera device 10 comprises an MPU (Main Processing Unit) 20, and a memory 21. The MPU controls overall processing operations and controls protection processing or setting of a protecting region which are features of the present invention described later. The memory 21 stores a program which governs these operations, provides a work area for carrying out processing operations for an image signal, and stores screen data or the like for coordinate information contained in a protecting region or an alarm display to be displayed during motion detection or the like.

Furthermore, the network camera device 10 is connected to the MPU 20 via a data bus, and comprises an Ethernet communication portion 18, a wireless LAN (Local Area Network) communication portion 19, and a router portion 27. Via a wired network N or a wireless network, for example, communication processing is carried out between the camera device and an external PC 26. Further, via an external DSL modem 29 or the like, connection to the Internet or the like can be made.

Moreover, the network camera device 10 is connected to the MPU 20 via a data bus to be controlled and comprises: a pan driver 22 for driving a camera unit C in a pan direction, and a pan motor 24 such as a stepping motor, and further, a tilt driver 23 for further driving the camera unit C in a tilt direction, and a tilt motor 25 such as a stepping motor. Here, the camera unit C comprises at least the above-described objective lens 11 and solid image pickup element 13.

A plurality of network camera devices 10, as shown in FIG. 2, can be also provided via a network N. Further, drive processing in the pan direction or tilt direction of the network camera device 10 can be carried out by the PC 26 or the like via the network N. Additionally, monitoring of an image signal picked up by the network camera device 10 or recording and reproducing processing can be carried out. In addition, a pointing device such as a mouse 29 is connected to the PC 26. In particular, setting of a protecting region described later can be easily carried out.

The network camera device 10, as shown in FIG. 3, also comprises the camera unit C; the pan motor 24 for driving the camera unit in a pan direction; the tilt motor 25 for driving the camera unit in a tilt direction, and an electrical package portion 10-1 having the other configuration shown in FIG. 1.

(Router Portion According to the Present Invention)

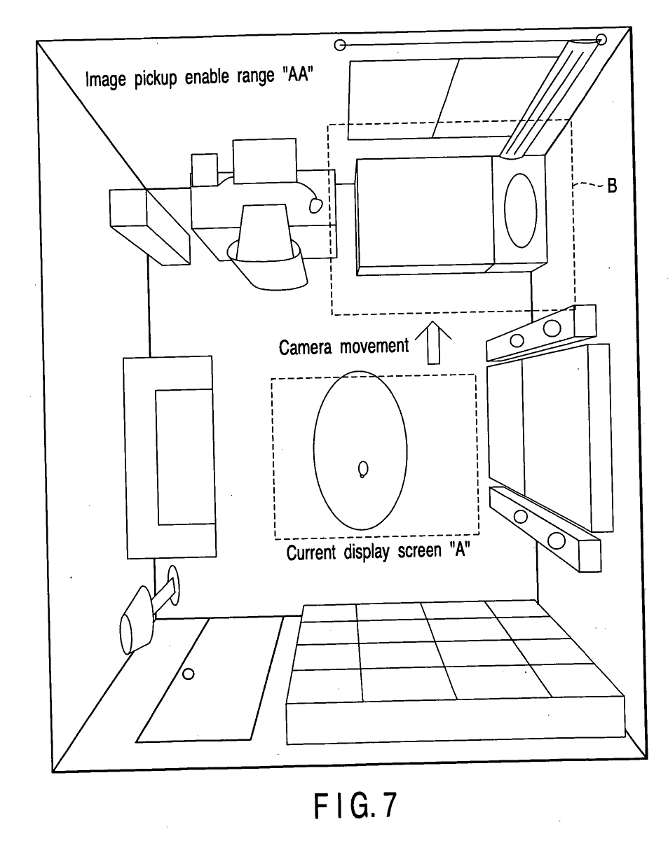

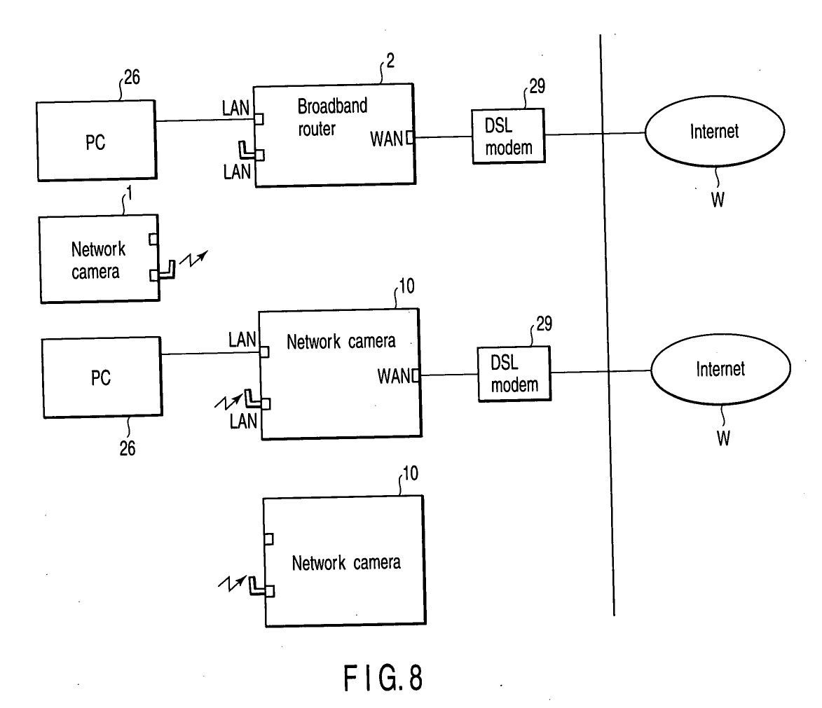

Now, with reference to FIG. 7, a description will be given with respect to a router portion 27 provided at the inside of a cabinet of an image pickup device according to the present invention. In FIG. 7, in an image pickup device 1 serving as a network camera which does not comprise the router portion 27 provided as a feature of the present invention, when connection to a wide area network (such as the Internet) W is made, connection is made to the DSL modem 29 via a broadband router device 2 or the like which is externally installed via its own LAN or wireless LAN, and a signal is supplied from the wide area network (such as the Internet). Therefore, since a system becomes complicated, operational reliability is degraded while there is a disadvantage that a large area of installation is required, resulting in higher cost.

On the other hand, in the image pickup device 10 which is a network camera according to the present invention, a router function is incorporated in the cabinet. Thus, this device is structurally rigid, is improved in operational reliability, and at the same time, can reduce cost. In addition, by using the router function, a function for relaying image information with a network camera on another network is improved.

(Basic Operation)

The network camera device 10 having such a configuration carries out basic operations as described below. That is, the network camera device 10 can carry out: an image pickup operation for receiving incident light from an object and supplying an image signal according to the image pickup screen via a network or the like; a camera drive operation for driving the direction of the camera unit C in, for example, a pan direction or a tilt direction; a variety of setting operations for setting operating modes (for example, motion detecting operation) based on a picked-up image signal or a protecting region for protection processing described later; a self test operation and the like.

That is, in the image pickup operation, a command signal is received from the PC 26 or the like which is a control device, via the network N (or wireless network) or wide area network (such as the Internet) W, and operation is carried out under the control of the MPU 20 according to an operating program stored in the memory 21. The solid image pickup element 13 having received incident light from an object via the objective lens 11 supplies a detection signal according to the incident light to the image processing portion 16. After predetermined image processing has been applied, the image compression portion 18 carries out image compression such as JPEG compression or MPEG compression, and the compressed image is externally outputted via the Ethernet communication portion 18, wireless LAN communication 19 or router portion 27.

In the camera drive operation, after zero coordinate adjustment has been made in the pan motor 24 and tilt motor 25 which are stepping motors, the MPU 20 always recognizes a direction of the current camera unit C. In this manner, the MPU 20 always manages the coordinate of a screen picked up by the current camera unit C. According to an operation control signal supplied from the MPU 20 to a driver, the camera unit C is driven in a pan direction or a tilt direction, the image pickup screen changes, and at the same time, the MPU 20 always recognizes the coordinate of the current image pickup screen. Therefore, a user can move the camera unit C in a pan direction or a tilt direction while looking the image pickup screen according to an image signal which is continuously supplied by the current image pickup device 10, and can look the image pickup screen according to the movement. In addition, the MPU 20 recognizes and manages the coordinate of the current image pickup screen. The user can also acquire the coordinate information of the current image pickup screen on, for example, the PC 26 according to an operation.

In each of the operating modes, for example, a motion detecting operation mode, the image pickup device 10 automatically detects a motion of an image in an arbitrary region set by the user. That is, in the motion detecting operation mode, after an observation region of the motion detection in the image pickup screen has been set in accordance with the user's operation, when a change whose value is equal to or greater than a predetermined value on the image pickup screen is detected in that observation region in a set period of time, the MPU 20 determines that such motion is detected. For example, the MPU 20 carries out an operation such as an alerting operation, i.e., outputting an alarm signal, or alternatively, adding the alarm screen stored in the memory 21 in an image signal and outputting.

(Communication Method with Protection Processing)

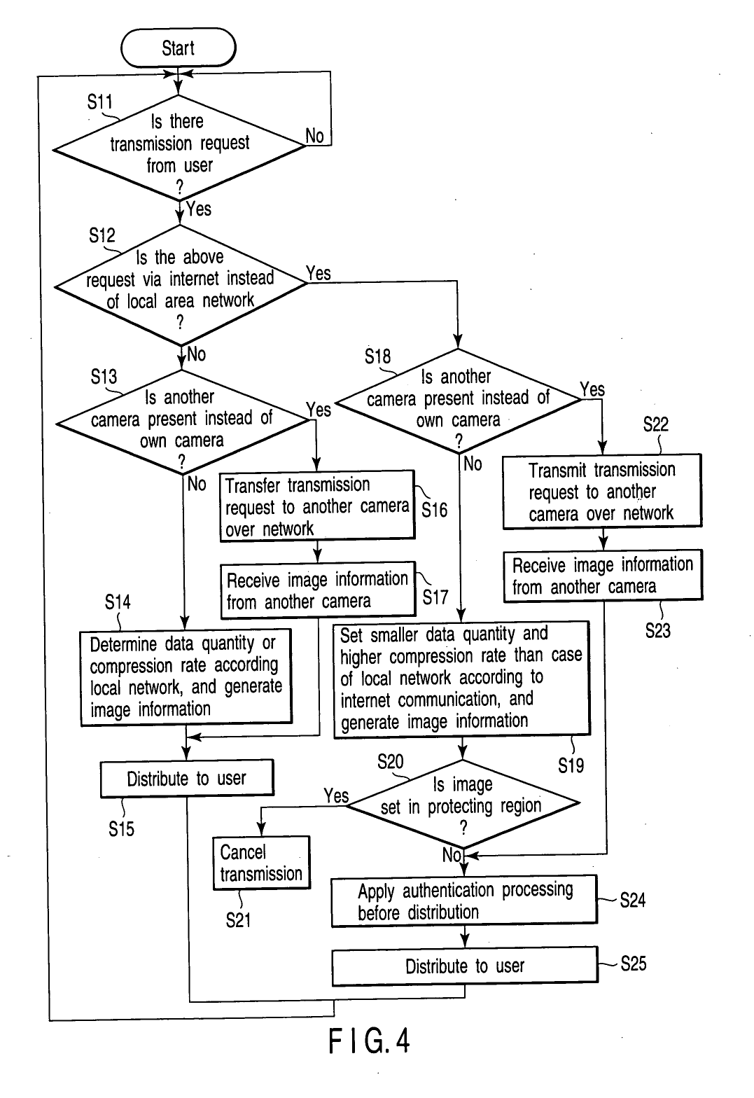

Now, a communication method with protection processing for the image pickup device according to the present invention will be described below in detail with reference to FIG. 4. Here, FIG. 4 is a flow chart showing an example of a communication method with protection processing for the image pickup device according to the present invention; and FIG. 7 is an illustrative view illustrating an example of setting a transmission protecting region in an image pickup enable range.

In FIG. 4, a description will be given by example of a case of receiving a request signal from, for example, a user, and in response to this request, transmitting image information picked up by the solid image pickup element 13 when the image pickup device 10 according to the present invention is provided as an image pickup portion. If the user requests a transmitting signal (S11), it is determined whether the signal is sent from a device over the local area network via the Ethernet communication portion 18 or the wireless LAN communication portion 19 or from a device over the Internet via the router portion 27 or external DSL modem 29 (S12).

When the signal is sent from the device over the local area network, it is then determined whether the signal is a request for transmitting image information from its own network camera or a request for transmitting image information from a network camera over another network (S13). When the signal is the request for transmitting image information from its own network camera, a data quantity and a compression rate of an image signal targeted for transmission from the picked-up image information are decided according to the local area network (S14). In this case, the value of data quantity is set to be equal to or greater than and the compression rate is set to be equal to or smaller than at least the data quantity and compression rate of the image signal supplied to the device over the Internet in the step S19 described later, respectively. This is because the local-area network has a higher communication capability. Thus, the image signal produced for the local area network is transmitted to the user having the device over the local area network (S15).

Next, when the request signal requests image information on another camera over the network in step S13, the transmission request signal is transmitted to another network camera over the network specified by the request signal with the function of the MPU 20 (S16). Then, image information is received from another network camera over the network having received this transmission request signal (S17). At this time, the image pickup device 10 which is a network camera according to the present invention comprises the router portion 27, thus making it possible to efficiently carry out relay processing for such an image. The received image information is then transmitted to the device over the network having transmitted the transmission request signal (S15).

Further, in the case where the transmission request signal is sent from the device over the wide area network (such as the Internet) W via the router 27 in step S12, it is then determined whether the signal is sent from a request for transmitting image information from its own network camera or a request for transmitting image information from a network camera over another network (S18). When the signal is the request for transmitting image information from its own network camera, the data quantity and compression rate of an image signal targeted for transmission from the picked-up image information are decided according to the Internet communication (S19). In this case, the value of data quantity is set to be equal to or smaller than and the compression rate is set to equal to or higher than at least the data quantity and compression rate of the image signal supplied to the device over the local area network in the above-described step S14, respectively. This is because the wide area network 20. (such as the Internet) W has a lower communication capability than the local area network in general.

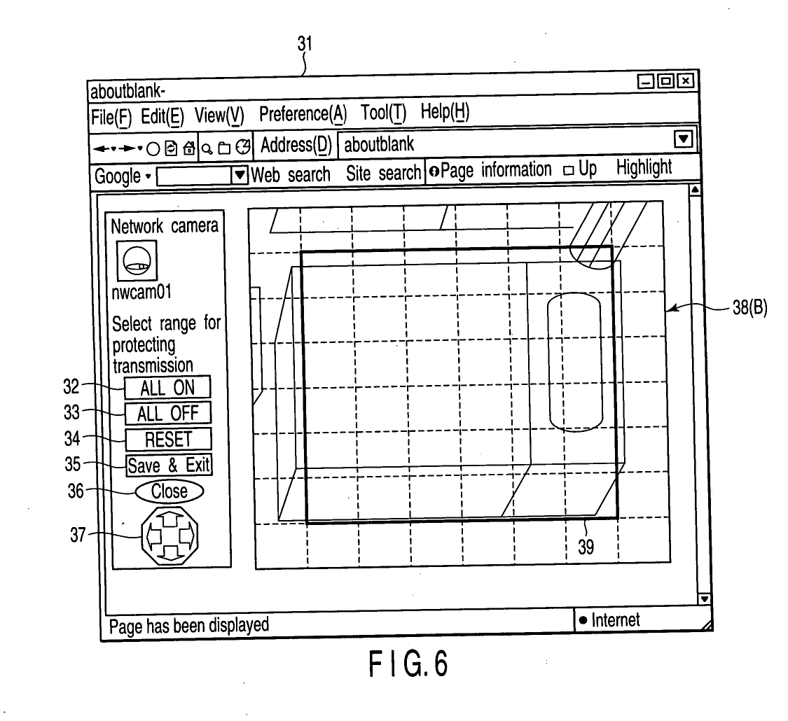

Furthermore, it is determined whether or not image information to be transmitted is image information set by processing for setting a protecting region described later (S20). That is, in FIG. 7, an image pickup enable range AA denotes a range in which an image can be picked up by arbitrarily changing an image pickup direction by using the above-described pan motor 24 and tilt motor 25, and for example, the inside of a private room is shown here. With the method described later, the user can set a protecting region freely. Assume that, for example, a protecting region 39 in FIG. 6 in a screen B including a bed in room is set as a protecting region. That is, this example is intended to prevent an image of the bed in the private room from being dispersed over the Internet by mistake.

With respect to image information contained in this protecting region, even if a transmission request signal requests transmission, such transmission is canceled under the determination of the MPU 20 (S21). In addition, even if the transmission is not canceled, it is preferred to protect that region by applying mosaic processing to that region, cutting it out, or replacing it with another item of image information.

Further, when image information is transmitted to the wide area network (such as the Internet) W, authentication processing is carried out together with a device of a transmission destination. That is, authentication processing such as checking input is applied by acquiring a device ID signal or prompting a desired password input from the device side (S24). Thereafter, the image signal produced for the Internet communication is transmitted to the user having the device over the wide area network (such as the Internet) W via the router portion 27 (S25). Thus, image protection processing or authentication processing is carried out, thereby making it possible to prevent image information which is privacy information from being dispersed over the Internet by mistake.

Moreover, in step S18, when a request signal requests image information from another camera over the network, the transmission request signal is transmitted to another network camera over the network specified by the request signal with the function of the MPU 20 (S22). Then, image information is received from another network camera over the network having received this transmission request signal (S23). At this time, the image pickup device 10 which is a network camera according to the present invention comprises the router portion 27, thus making it possible to efficiently carry out relay processing for such an image. After the above-described authentication processing has been carried out (S24), the received image information is transmitted to the device over the wide area network (such as the Internet) W having transmitted the transmission request signal (S25).

According to the present invention, as described above, it is determined whether a transmission destination of image information is a device over a LAN or a device on a wide area network (such as the Internet) W. In particular, in the case of transmission to the device over the Internet, security is improved so as to prevent dispersion of privacy information by carrying out protection processing or authentication processing.

In the above-described flow chart of FIG. 4, a case of receiving a request signal from the user and transmitting the signal in response to such a request has been described by way of example. However, in the case where image information is automatically supplied to the device over the wide area network (such as the Internet) W according to the settings provided in the memory 21, the steps other than the step 11 are identical. Here, in step S12, it is determined that the device of the set transmitted destination is over the local network or over the Internet.

(Operation for Setting Protecting Region)

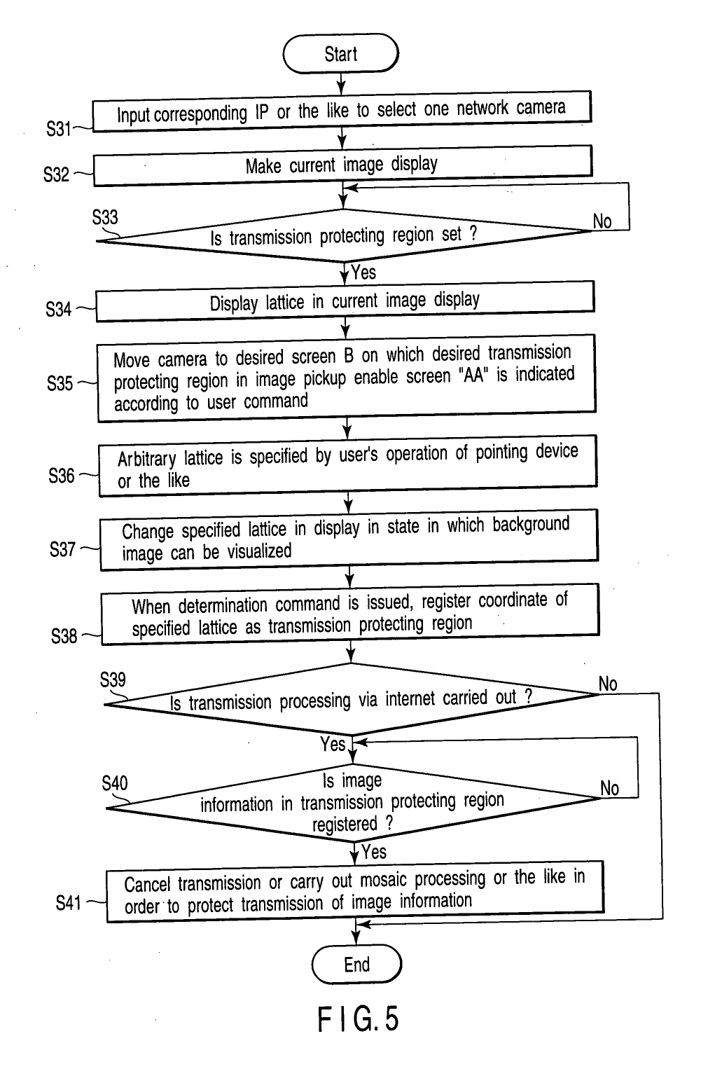

Now, an operation for setting a protecting region targeted for protection processing of the above-described image information will be described below in detail with reference to the flow chart. FIG. 5 is a flow chart showing an example of a method for setting a protecting region of the image pickup device according to the present invention. FIG. 6 is an illustrative view illustrating a relationship between an image pickup enable range AA and a protecting region in the method for setting the protecting area of the image pickup device according to the invention.

The protecting region of the image pickup device 10 according to the present invention is set in at least two cases described below. In one case, the protecting area is set in a current display screen A for currently displaying the protecting region. In the other case, as shown in FIG. 6, in the image pickup enable range AA in which an image can be picked up in a range of a function of driving the image pickup device 10, the camera unit C is moved in a pan direction or a tilt direction by the user's operation; the current display screen A is moved to a desired screen B; and an arbitrary region in the desired screen B is set as a protecting region 39.

Here, as an example of the operating for setting the protecting region according to the present invention, a description will be given below with respect to a case in which, with reference to the flow chart of FIG. 5, in the image pickup enable range AA, the camera unit C is moved in a pan direction or a tilt direction by the user's operation, whereby the current display screen A is moved to the desired screen B, and an arbitrary region in the desired screen B is set as the protecting region 39.

In the image pickup device 10 according to the invention, an IP address signal specified from a control device such as the PC 26 over the network is first supplied. When it is determined that the Ethernet 18 or wireless LAN communication portion 19 of the image pickup device 10 corresponds to this address signal, one image pickup device 10 operates under the control of the PC 26 or the like (S31). Here, when a command for image pickup operation is received from the PC 26, the image pickup operation is made under the control of the MPU 20. Then, the detection signal according to incident light is supplied from the solid image pickup element 13 to the image processing portion 16. In the image processing portion 16, image processing functions such as, for example, sharpness processing, contrast processing, Gamma correction, white balance processing, and pixel addition processing are applied to the inputted image signal. Then, in the image compression portion 17, JPEG compression or MPEG compression processing is applied, and the compressed image signal is outputted via either of the Ethernet communication portion 18 and wireless LAN communication portion 19. The outputted image signal is displayed on a screen of a browser application 31 shown in FIG. 4, for example, after decompression processing has been applied in the PC 26, for example (S32).

When a mode for setting a protecting region is selected by the user (S33), the current image pickup screen 37 is displayed together with operating icons 32 to 37 in an operating region on the screen of the browser application 31 as shown in FIG. 4. At this time, it is preferred that the screen is displayed to be divided into a plurality of blocks (lattices) as an example (S34). That is, a unit of regions in which the protecting region can be set is specifically displayed, thereby making it possible for the user to set a region for an object reliably.

Here, the operating icons are provided as icons for the protecting region setting mode; an “ALL ON” icon 32 is provided as an icon for defining the entire screen as a protecting region; an “ALL OFF” icon 33 is provided as an icon for canceling the protecting region of the entire screen; a “RESET” icon 34 is provided as an icon for canceling the protecting region specified by a pointing device such as a mouse and returning it to a default value; a “Save&Exit” icon 35 is provided as an icon for determining the protecting region specified by a pointing device such as a mouse and exiting the protecting region setting mode; a “Close” icon 36 is provided as an icon for closing this screen; and an arrow icon 37 is provided as an icon for moving the camera unit C in a pan direction or a tilt direction.

A desired region can be set not only by setting the protecting region according to the present invention in the current display screen A as shown in FIG. 6, but also by setting the image pickup enable range AA enabling image pickup by driving the camera unit C in a pan direction or a tilt direction. Therefore, the user moves the camera from the current display screen A shown in FIG. 7 to the desired screen B by operating the arrow icon 37 or the like (S35). Then, an arbitrary block (lattice) can be specified as the protecting region 39 by the user's operation of a pointing device such as a mouse 29 (S36). The MPU 20 having received this coordinate information and a command signal from the PC 26 or the like via the network makes an active display in a semitransparent rectangular block or the like, as shown in FIG. 4, while this region is defined as the protecting region 39 in a state in which a background image can be visualized (S37).

If a failure occurs in this region, when the user supplied a command signal to the MPU 20 via the network again by mouse operation or the like, this active display is released, and processing reverts to a normal image pickup display similar to another region.

In this manner, the user can specify a region very intuitively.

Finally, the user operates the “Save&Exit” icon 35, for example, to decide the currently actively displayed region as the protecting region 39, and supplies a determination signal via a network and a command signal to the MPU 20. When this decision command is issued, the coordinate of the specified block (lattice) is registered as a new protecting region in, for example, the memory 21 or the like (S38).

In this manner, on the setting screen of FIG. 4, the image contained in the protecting region 39 is displayed, making it possible for the user to reliably set an object targeted for protection processing in a protection region by making a very easy and intuitive operation.

In this way, the user can protect image information in the protecting region easily set by operation of, for example, the mouse 29 or the like which is a pointing device depending on, for example, the screen of the PC or the like over a network. In addition, connection can be made to the Internet which is a communication method with high expandability, while maintaining security.

One skilled in the art can achieve the present invention according to the various embodiments described above. Further, a variety of modifications of these embodiments can be easily conceived by one skilled in the art, and the present invention can be applied to a variety of embodiments even if one skilled in the art has no inventive ability. Therefore, the present invention covers a wide range which is not contradictory to the disclosed principle and novel features, and is not limited to the above-described embodiments.

1. An image pickup device comprising:
an image pickup portion which picks up an image;
a communication portion which makes communication via a local area network; and
a router portion connected to the communication portion, the router portion transmits image information picked up by the image pickup portion via one of the local area network and a wide area network.

2. An image pickup device according to claim 1, further comprising:
a control portion which receives an image transmission request signal from a device over the wide area network via the router portion, in response to the received signal, carries out protection processing for the image information picked up by the image pickup portion according to setting, and controls the protected information to be transmitted to the device over the wide area network via the router portion.

3. An image pickup device according to claim 2, wherein the protection processing of the control portion transmission does not transmit image information in a set protecting region or transmits the information after mosaic processing or the like has been applied thereto.

4. An image pickup device according to claim 1, further comprising:
a control portion which determines transmission to a device over the local area network or transmission to a device over the wide area network, and when the determination result is transmission to the device over the wide area network, controls a signal to be transmitted after being produced at a higher compression rate than a case of transmission to the device over the local area network or a signal to be transmitted after produced in an image information unit of a small capacity.

5. An image pickup device according to claim 1, further comprising:
a control portion which, when a transmission request signal of image information picked up by another image pickup device over the local area network is received via the communication portion or router portion, controls the request signal to be transmitted to the another image pickup device, and when image information is acquired according to the transmission, controls the image information to be transmitted via the communication portion or router portion.

6. An image pickup device according to claim 1, further comprising:
a control portion which, after a protecting region has been set in an image pickup enable range of the image pickup portion, when a transmission destination of the image information picked up by the image pickup portion is a device over the wide area network via the router portion, carries protection processing for an image in the protecting region of the image information, and controls the protected image to be transmitted.

7. An image pickup device according to claim 6, wherein, in processing of setting the protecting region carried out by the control portion, in a state in which the image picked up by the image pickup portion is displayed as a plurality of block regions on a display screen of external equipment communicated via the communication portion or the router portion, in the case where a predetermined region on the display screen has been specified together with a command signal, the predetermined region is displayed in the image in a state in which the region can be identified from another region, and setting of the protecting region is carried out.

8. An image pickup device according to claim 6, wherein, in the case where a predetermined region on the display screen has been specified, area information produced to be displayed in the image in a state in which a user can identify an image in the predetermined region from an image in another region is similarly outputted via the communication portion.

9. An image pickup device according to claim 6, further comprising:
an image compression portion which image-compresses the picked-up image information to display a Browser Application in the external equipment via the communication portion or router portion.

10. An image pickup device according to claim 6, further comprising:
at least one of a drive portion which drives the image pickup portion in a pan direction and a drive portion which drives the image pickup portion in a tilt direction,
wherein the control portion can set the protecting region in an image pickup enable range in which an image can be picked up by movement of the image pickup portion using the drive portion, and carries out protection processing for image information picked up at the image pickup portion based on the protecting region.

11. An image pickup method comprising:
picking up an image to output image information; and
externally transmitting the picked up image information by using a communication portion provided in the image pickup device which makes communication via a local area network, and a router portion connected to the communication portion and provided in the image pickup device which makes communication via the local area network or a wide area network.

12. An image pickup method according to claim 11, wherein the control receives an image transmission request signal from a device over the wide area network via the router portion, and in response to the received signal, carries out protection processing for the image information according to setting, and controls the protected information to be transmitted to the device over the wide area network via the router portion.

13. An image pickup method according to claim 11, wherein protection processing in the control does not transmit image information in a set protecting region or transmits the image information after mosaic processing or the like has been applied thereto.

14. An image pickup method according to claim 11, wherein the control determines transmission to a device over the local area network or transmission to a device over the wide area network, and when the determination result is transmission to the device over the wide area network, a signal is produced and transmitted at a higher compression rate than a case of transmission to the device over the local area network or a signal is produced and transmitted in an image information unit of a small capacity.

15. An image pickup method according to claim 11, wherein, when a transmission request signal of image information picked up by another image pickup device over the local area network is received via the communication portion or router portion, the control transmits the request signal to the other image pickup device, and when image information is acquired in response to the transmitted signal, the acquired image information is transmitted via the communication portion or router portion.

16. An image pickup method according to claim 11, wherein, after a protecting region is set in an image pickup enable range of the image pickup, when a transmission destination of the image information is a device over the wide area network via the router portion, the control carries out protection processing for an image in the protecting region of the image information, and transmits the protected image.

17. An image pickup method according to claim 16, wherein, in processing of setting the protecting region, in a state in which the picked-up image is displayed as a plurality of block regions on a display screen of external equipment communicated via the communication portion or the router portion, in the case where a predetermined region on the display screen has been specified together with a command signal, the predetermined region is displayed in the image in a state in which the region can be identified from another region, and setting of the protecting region is carried out.

18. An image pickup method according to claim 16, wherein, in the case where a predetermined region on the display screen has been specified, area information produced to be displayed in the image in a state in which a user can identify an image in the predetermined region from an image in another region similarly is outputted via the communication portion.

19. An image pickup method according to claim 16, wherein the picked up image information is image compressed to display a Browser Application in the external equipment via the communication portion or router portion.

20. An image pickup method according to claim 16, wherein, in the case where an image pickup portion which carries out the image pickup is driven in a pan direction, and then, is driven in a tilt direction, the protecting region can be set in an image pickup enable range in which an image can be picked up, and protection processing for the image information is carried out based on the protecting region.
